(19) United States
(12) Patent Application Publication
(10) Pub. No.: US 2025/0384306 A1
(43) Pub. Date: Dec. 18, 2025

(54) MECHANISMS FOR GENERATING PREDICTIONS UTILIZING BLOCKCHAINS

(71) Applicant: PayPal, Inc., San Jose, CA (US)

(72) Inventor: Adhish Nayanendu Vyas, Gilroy, CA (US)

(21) Appl. No.: 18/744,238

(22) Filed: Jun. 14, 2024

(51) Int. Cl. G06N 5/022

(52) U.S. Cl. CPC G06N 5/022

(57) ABSTRACT

Techniques are disclosed pertaining to generating a prediction as to whether a user will perform certain operations. A computer system may deploy, to a set of blockchains, program code that is executable to perform an operation of a first operation type in response to the user performing an operation of a second operation type with respect to a web service system. The computer system can receive, from the web service system, a request to generate a prediction as to whether the user will interact with the web service system to perform a set of operations of the second operation type. The computer system may access operation history information, from the set of blockchains, pertaining to the user that identifies a set of previous operations performed by the user. The computer system generates the prediction based on the operation history information and provides the prediction to the web service system.

### BACKGROUND

### Technical Field

This disclosure relates generally to computer systems and, more specifically, to various mechanisms for generating a prediction as to whether a user will perform a set of operations based on previously executed operations recorded on a blockchain.

### Description of the Related Art

Enterprises are increasingly utilizing blockchain technology to enhance the services that they provide to their users. Blockchain technology refers to a framework that supports a trusted ledger that is stored, maintained, and updated in a distributed manner in a peer-to-peer network. Blockchain technology can be used in a variety of different fields. One common use of blockchains is in a cryptocurrency application, such as Bitcoin, where the distributed ledger represents each transaction in units of the cryptocurrency that are transferred between entities. Though maintaining cryptocurrency transactions in the ledger is the most recognizable use of blockchain technology today, the blockchains may be used in other applications. As examples, a blockchain may be used to record database transactions performed by a database system or the progression of a workflow as steps of the workflow are performed. Blockchain technology can be applicable to any application where it is desirable to record data in an immutable manner and ensure the accuracy of that data.

### BRIEF DESCRIPTION OF THE DRAWINGS

FIG. 1 is a block diagram illustrating one embodiment of a system having a prediction system capable of generating a prediction as to whether a user will perform a set of computer operations with respect to a web service system.

FIG. 2A is a block diagram illustrating one embodiment pertaining to a gatherer engine of a prediction system collecting information based on a blockchain address.

FIG. 2B is a block diagram illustrating one embodiment pertaining to a gatherer engine of a prediction system collecting information based on a user ID.

FIG. 3 is a block diagram illustrating one embodiment pertaining to a prediction engine of a prediction system generating a prediction using a machine learning (ML) model and/or a set of prediction criteria.

FIG. 4 is a block diagram illustrating one embodiment pertaining to the deployment and invocation of program code stored in a block of a blockchain.

FIG. 5 is a flow diagram illustrating one embodiment pertaining to a web service system invoking program code based on a prediction from a prediction system.

FIG. 6 is a block diagram illustrating one embodiment pertaining to a prediction engine training a ML model based on a result generated from the execution of one or more functions of program code stored in a block of a blockchain.

FIG. 7 is a flow diagram illustrating one embodiment of a method for predicting, based on an operation history stored by a blockchain, whether a user will interact with a web service system.

FIG. 8 is a flow diagram illustrating one embodiment of a method for predicting whether a user will interact with a web service system based on two different sets of operation history.

FIG. 9 is a block diagram illustrating elements of a computer system for implementing various systems described in the present disclosure, according to some embodiments.

### DETAILED DESCRIPTION

In many cases, it can be desirable for a user to perform certain operations facilitated by computer systems. For example, having a user enable two-factor authentication at a system can significantly reduce the risk of unauthorized access to their account at the system. As another example, having a developer implement rigorous testing of their application before deploying it onto a platform can help to prevent the exploitation of that application and also the platform via the application. As yet another example, having individuals keep records of activities in a certain format can allow that information to be more readily indexed and used. Accordingly, the operations that it may be desirable for a user to perform can include any type of computer operation performable by a user, such as authentication/verification interactions (e.g., logins), registration interactions (e.g., signups), transaction interactions, etc.

Often, a user can be encouraged (in different ways) to perform certain operations. As an example, providing users with access to additional features can cause them to enable two-factor authentication. As another example, prioritizing the execution of applications that have been rigorously tested can cause developers to implement good testing practices. But in some cases, a user cannot be driven to perform an operation and thus it may be beneficial to a system to not expend resources attempting to cause the user to perform the operation. Since some users cannot be driven to perform an operation, it can be desirable to identify or predict which users can be. Accordingly, the present disclosure addresses, among other things, the problem of how to predict whether a user will interact with a system, such as a web service system, to perform certain operations.

Blockchains can store a wide range of information, including data indicative of a user's behavior. For example, a blockchain may contain one or more records that describe previous operations performed by the user—e.g., previous two-factor authentication registrations at one or more systems, previous tests performed on an application, etc. Leveraging this information stored on a blockchain may result in improved predictions as past behavior is often indicative of future behavior. Accordingly, this disclosure also addresses the problem of how to leverage a blockchain when generating a prediction as to whether a user will interact with a system to perform certain operations.

The present disclosure describes embodiments in which a prediction system generates a prediction as to whether a user will interact with a web service system to perform operations of a first operation type. As described in various embodiments below, a prediction system can receive a prediction request from a web service system that requests the prediction system to analyze a user's behavior/history to generate the prediction. The prediction request can contain identification information associated with the user, such as their blockchain address. Using that information from the prediction request, the prediction system can access records stored in the blocks of a blockchain system that describe prior operations performed by that user. For example, a prediction system may access a record that describes a prior transaction performed by a particular user based on their blockchain address. In various embodiments, the prediction system processes the records accessed from the blockchain system, using techniques such as a trained machine learning model, to generate the prediction. For example, the prediction system may use a statistical model to generate a score that represents the likelihood that the user will perform a sign-up on a website. After generating the prediction, the prediction system provides that prediction to the web service system.

In various embodiments, the prediction system also separately deploys program code to a block of the blockchain system that is executable to perform an operation of a second operation type with respect to the user in response to the user performing an operation of the first operation type. For example, the program code may be executable to provide the user with access to additional features at the web service system in response to the user enabling two-factor authentication at the web service system. Upon receiving the prediction, the web service system may provide input data to the deployed program code to facilitate the operation of the second operation type based on a detection that the user has performed the operation of the first operation type. If the user performs the operation of the first operation type, then the program code may detect it and perform the operation of the second operation type.

These techniques may be advantageous as they allow for a prediction to be generated as to whether a user will perform a particular operation, where the generation of that prediction can leverage blockchain technology. By analyzing records of a blockchain that are associated with a user, a system may be able to generate more accurate predictions than the system would otherwise if the system did not leverage the blockchain. Furthermore, by providing predictions to a web service system, the web service system can better utilize its resources when attempting to motivate a user to perform certain operations. As a result, a web service system can enhance its service to provide a customized user experience and increase user satisfaction. Moreover, by deploying, to a blockchain, program code that implements one or more operations when the user performs the desired operation, these techniques can prevent the program code from being modified while being publicly accessible. These various advantages represent an improvement to computer systems (e.g., a system can better utilize its resources based on the predictions that are generated).

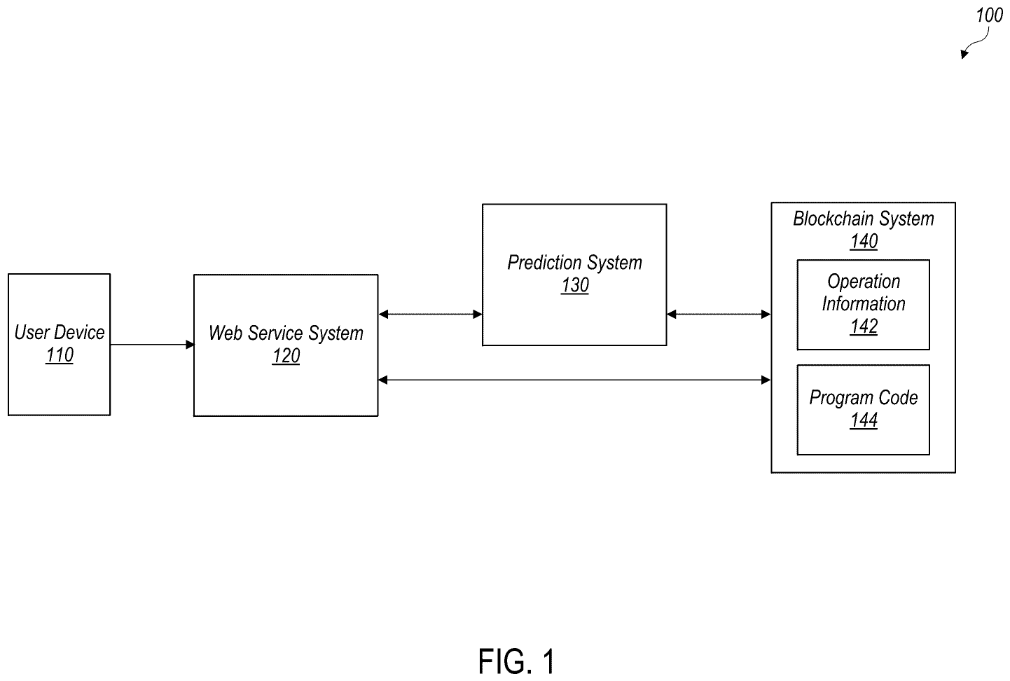

Turning now to FIG. 1, a block diagram of a system 100 is shown. System 100 includes a set of components that may be implemented via hardware or a combination of hardware and software routines. In the illustrated embodiment, system 100 includes a user device 110, a web service system 120, a prediction system 130, and a blockchain system 140. As further depicted, blockchain system 140 includes operation information 142 and program code 144. In some embodiments, system 100 is implemented differently than shown. As an example, prediction system 130 may also store operation information describing one or more operations performed by a user associated with user device 110. As another example, multiple web service systems 120 may interact with prediction system 130.

System 100, in various embodiments, is a platform that provides one or more services (e.g., a cloud computing service, a customer relationship management service, and a payment processing service) that are accessible to users that can invoke functionality of the services to achieve a user-desired objective. In order to facilitate the functionality of those services, system 100 may execute various software routines as well as provide code, web pages, and other data to users, databases, and other entities that use system 100. In various embodiments, system 100 is implemented using a cloud infrastructure that is provided by a cloud provider. Components of system 100 may therefore execute on and use available resources of that cloud infrastructure (e.g., computing resources, storage resources, etc.) to facilitate their operation. Accordingly, software for implementing the service(s) of prediction system 130 (or another component of system 100) may be stored on a non-transitory computer-readable medium of server-based hardware included in a datacenter of the cloud provider. That software may be executed in a virtual environment that is hosted on the server-based hardware. In some cases, a component is implemented without the assistance of a virtual machine or other deployment technologies, such as containerization. In some embodiments, one or more components of system 100 may be implemented using a local or private infrastructure as opposed to a public cloud.

User device 110 may be any of a variety of different computer systems that a user can use to interact with web service system 120 (e.g., send a request, such as an HTTP (hypertext transfer protocol) request, over a network to access a service provided by web service system 120). In some embodiments, user device 110 is a mobile device such as a mobile phone, a tablet computer, a handheld computer, a laptop or notebook computer, a personal data assistant, a consumer device, etc. In some embodiments, user device 110 is an internet of things (IOT) device, a server system, a desktop computer, a mainframe computer system, a workstation, network computer, etc. In some embodiments, user device 110 is a wearable device such as a watch, athletic sensor, or a head mounted display, which may be a headset, helmet, goggles, glasses, a phone inserted into an enclosure, etc. As will be discussed, web service system 120 may provide a website-based service accessible to users via user devices 110. The website of the service may include various web pages that can be written in HTML (hypertext markup language) and viewed by a user via a web browser on user device 110. In some embodiments, a provider of web service system 120 may provide an application that can be executed on user device 110—e.g., the user downloads a native application onto their device via an application store.

Web service system 120, in various embodiments, is a system that provides a website-based service (e.g., a retail website) that is accessible via user device 110 over a communication network. Web service system 120 may receive network traffic (e.g., HTTP requests) requesting access to its web service from user device 110 via a web browser or a native application. For example, web service system 120 may provide an online retail store that conducts transactions with the user of user device 110. Other examples of the services that may be provided by web service system 120 include an email service, a streaming service, a resource provisioning service (e.g., an IaaS), a platform service (e.g., a PaaS), and/or an online payment/transaction processing service. Since web service system 120 can provide one or more services, it can be considered a type of service provider system. In various embodiments, the service(s) provided by web service system 120 involve execution/transaction flows that comprise various steps, at least one of which can involve having prediction system 130 perform certain operations, such as generating and providing a prediction as to whether the user of user device 110 will interact with web service system 120 to perform certain operations in relation to the service(s) provided by web service system 120.

In some cases, web service system 120 may desire a user of user device 110 to perform a set of computer operations pertaining to web service system 120. For example, web service system 120 may desire a user to sign-up for two-factor authentication. As part of incentivizing the user to perform the operation(s), in various embodiments, web service system 120 sends a prediction request to prediction system 130 to determine a probability/prediction associated with the user. Prediction system 130, in various embodiments, is a system that generates, based on previously executed operations, a prediction indicative of whether a user will interact with the services of web service system 120 to perform a set of operations. For example, prediction system 130 may predict whether a user will create an account at web service system 120 based on previous sign-ups performed by the user at different web service systems 120. As a part of generating that prediction, in various embodiments, prediction system 130 accesses operation information 142 from blockchain system 140.

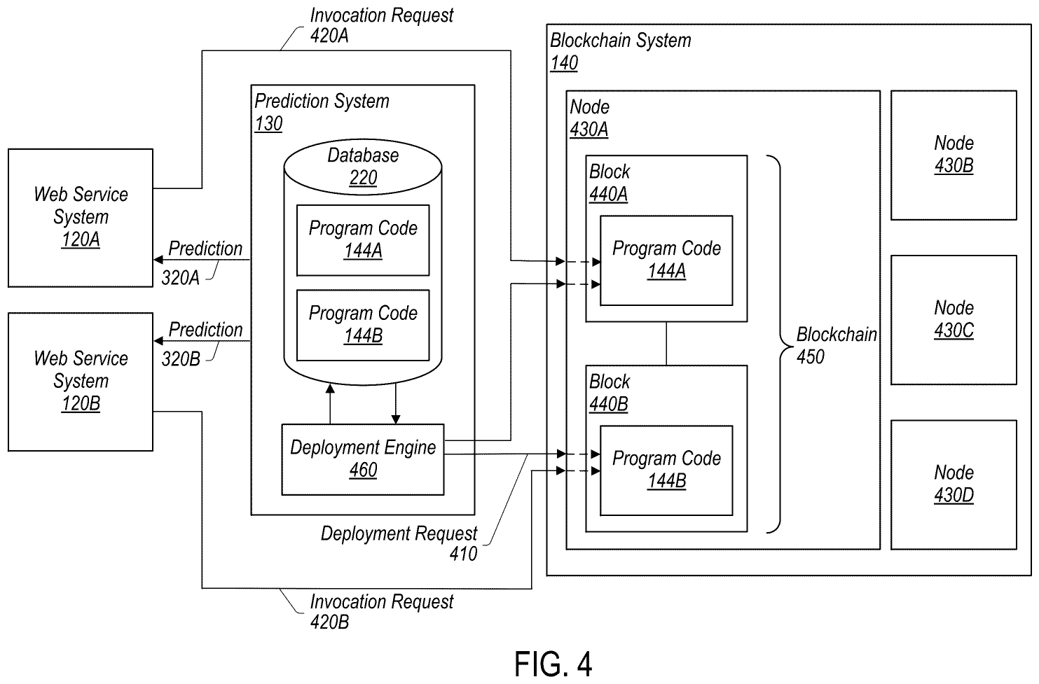

Blockchain system 140, in various embodiments, is a distributed system in which two or more computer systems/nodes store and maintain copies of a blockchain. The blockchain may be a digital ledger comprising blocks that store one or more records that describe computer operations. A computer operation may describe any type of computer operation facilitated by computer systems-examples of different types of operations include, but are not limited to, authentication/verification interactions (e.g., logins), registration interactions (e.g., signups), and payment transaction interactions. For example, a block of the blockchain may include a record that describes a transaction involving a set of entities. The term “transaction” does not necessarily refer to an interaction between entities that is financial in nature. As examples, a user may conduct a transaction in which a user signs up for a service or a database system may execute a transaction in which one or more database records are accessed. These non-financial transactions may be recorded on the blockchain of blockchain system 140. Blockchain system 140 is described in greater detail with respect to FIG. 4. Operation information 142, in various embodiments, is a set of records on a blockchain that are associated with the user of user device 110 and may describe various computer operations of a particular type (e.g., signups) that were previously performed by that user.

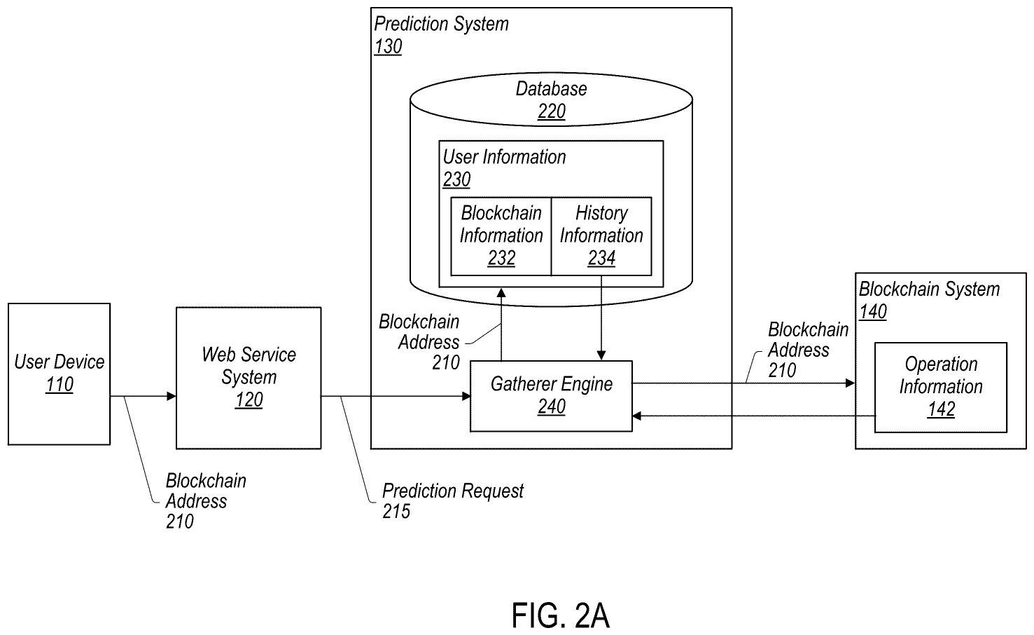

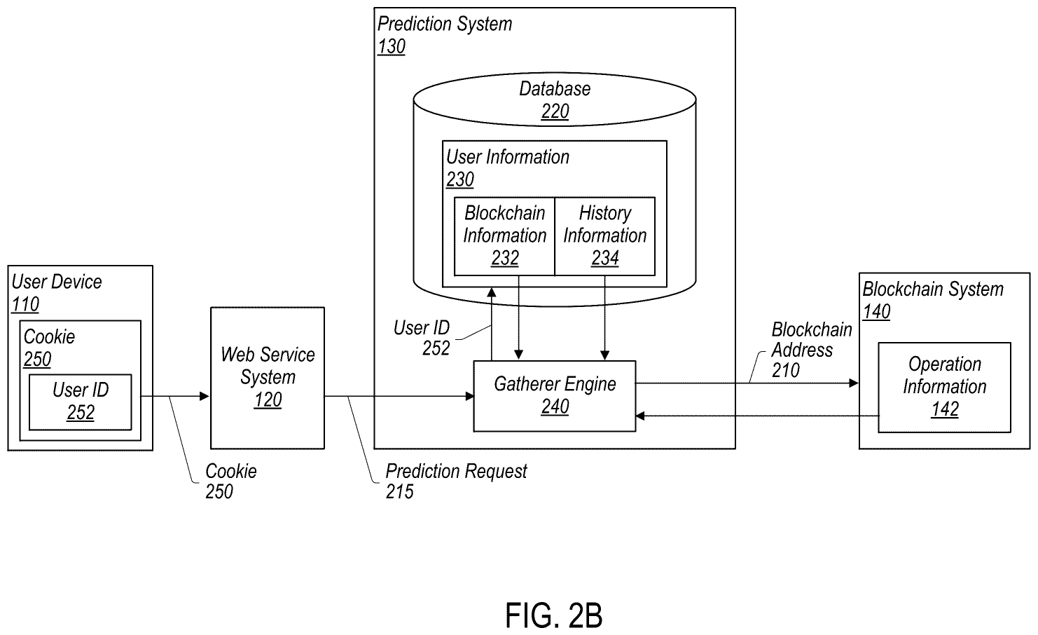

To obtain operation information 142, prediction system 130 may utilize a blockchain address to identify a set of records associated with the user for which the prediction is being made. A blockchain address, in various embodiments, is a unique identifier associated with an account or wallet of the user that is used in blockchain transactions. For example, a blockchain address may include an alphanumeric string of characters derived from a public key of a user by applying a cryptographic hash function to that public key. But the methods used for deriving the addresses may vary and may be specific to the implementation of the blockchain network. The blockchain address is described in greater detail with respect to FIG. 2A.

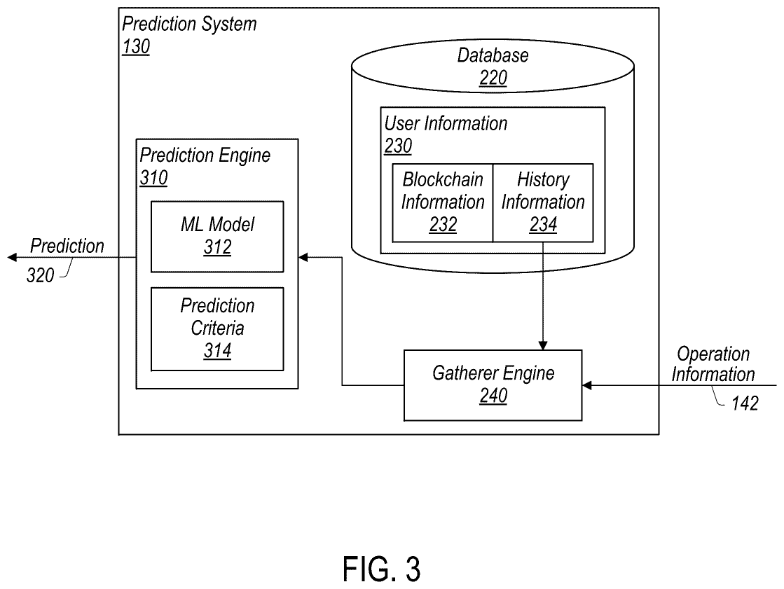

After obtaining operation information 142 from blockchain system 140, prediction system 130 may then generate a prediction based on operation information 142 and provide it to web service system 120. The generation of the prediction is discussed in greater detail with respect to FIG. 3. Based on this prediction, web service system 120, in various embodiments, provides input data to program code 144 that is stored in a block of the blockchain. Program code 144, in various embodiments, is executable to perform one or more computer operations that implement a “reward.” A smart contract is one example of program code 144. A reward, in various embodiments, is a benefit, compensation, and/or acknowledgment given to the user for performing the computer operation. A reward may be cryptocurrency (e.g., a stablecoin), cashback, loyalty points, coupons, exclusive access to features, free shipping, subscriptions, discounts, prioritization (e.g., systems resources prioritize the execution of an application), etc. For example, program code 144 may be executable to send a discount code to a user in response to determining that the user has performed a sign-up operation with respect to web service system 120. As another example, program code 144 may be executable to provide the user with access to one or more additional services of web service system upon the user enabling two-factor authentication. Accordingly, the input data provided by web service system 120 may identify properties of the operation to be performed by the user and the reward. If program code 144 detects (e.g., via the blocks of blockchain system 140) that the user performed the operation, then it may perform one or more operations to facilitate the identified reward.

Turning now to FIG. 2A, a block diagram of an example of prediction system 130 gathering data using a gatherer engine 240 based on a blockchain address 210 is shown. In the illustrated embodiment, prediction system 130 includes a database 220 and gatherer engine 240. As further depicted, database 220 includes user information 230 that describes blockchain information 232 and history information 234. In some embodiments, prediction system 130 is implemented differently than shown—e.g., user device 110 may provide a cookie instead of blockchain address 210.

As a user device 110 interacts with web service system 120, the user of user device 110 may provide information (e.g., identification information) to web service system 120 as part of invoking a service of web service system 120. For example, a user of user device 110 may add their blockchain address 210 to a user account associated with web service system 120 in order to perform a transaction. Blockchain address 210, in various embodiments, is a unique alphanumeric identifier associated with a user and is used to facilitate transactions with respect to blockchain system 140. In some embodiments, the user may link a user account associated with a different service provider (e.g., a payment/transaction processing service) to web service system 120 and that user account may include blockchain address 210—that is, the user may not directly provide blockchain address 210 to web service system 120. In the event that the user provides blockchain address 210 to web service system 120, web service system 120 may include blockchain address 210 in a prediction request 215 that it provides to prediction system 130.

Prediction request 215, in various embodiments, is a request to generate a prediction as to whether user device 110 will perform a set of operations with respect to web service system 120 based on one or more previously executed operations. For example, prediction system 130 may predict whether a user will sign up for multi-factor authentication for web service system 120 based on data associated with one or more previous sign-ups by the user on other web service systems 120. Prediction request 215 may include blockchain address 210 and/or other identification information associated with the user, such as the user's legal first and last name, an e-mail address, a phone number, biometric data, an account identifier for an account at prediction system 130, and/or internet protocol (IP) address.

As shown, prediction request 215 is received by gatherer engine 240. Gatherer engine 240, in various embodiments, is software that is executable to collect various information (e.g., operation information 230) associated with a user based on blockchain address 210. As such, in response to receiving prediction request 215, gatherer engine 240 may extract identification information from prediction request 215, such as blockchain address 210, in order to identify user information 230 stored in database 220.

Database 220, in various embodiments, is a collection of information that is organized in a manner that allows for access, storage, and/or manipulation of that information. Database 220 may include supporting software (e.g., storage servers) that enables a database system to carry out those operations (e.g., accessing, storing, etc.) on the information stored at database 220. In various embodiments, database 220 is implemented using a single or multiple storage devices that are connected together on a network (e.g., a storage attached network (SAN)) and configured to redundantly store information in order to prevent data loss. The storage devices may store data persistently and thus database 220 may serve as a persistent storage for system 100. Further, as discussed, components of system 100 may utilize the available cloud resources of a cloud infrastructure and thus the data of database 220 may be stored using a storage service that is provided by a cloud provider (e.g., Amazon S3®). As shown, database 220 stores user information 230 that describes one or more users associated with prediction system 130. The data stored at database 220 may include database records that comprise key-value pairs having data and a corresponding key that can be used to look up the associated record. Accordingly, user information 230 may be stored as one or more database records that are accessible using blockchain addresses 210.

In the illustrated embodiment, gatherer engine 240 uses blockchain address 210 to look up and collect history information 234 stored in database 220. History information 234, in various embodiments, includes one or more records describing computer operations that were previously performed by the user associated with blockchain address 210. History information 234 may include the type of computer operation (e.g., sign-up) performed by the user, metadata associated with the computer operation, information describing one or more web service systems 120 that facilitated the computer operation, timestamps associated with the computer operations, web browsing history, etc. For example, history information 234 may include data describing a transaction performed between a user and a merchant, such as the transaction type, transaction amount, transaction description, transaction status, etc. History information 234 may include records describing one or more computer operations that are associated with the user but were performed without using blockchain address 210. As an example, the user may conduct a transaction with web service system 120 that does not involve blockchain address 210 or the blockchain of blockchain system 140. The records of history information 234 may be accessed indirectly via blockchain address 210 as it may be used to identify a user ID that is associated with the user and then that user ID may be used to look up the records.

In the illustrated embodiment, gatherer engine 240 uses blockchain address 210 to collect operation information 142 from the blockchain of blockchain system 140. In particular, gather engine 240 may submit a request to blockchain system 140 for records associated with blockchain address 210 and blockchain system 140 may return any relevant records in response to that request. Operation information 142, in various embodiments, is a collection of records describing one or more computer operations that are recorded to the blockchain of blockchain system 140 and are associated with blockchain address 210. Operation information 142 may identify, for a given operation, its type (e.g., transaction), a sender's blockchain address 210, a receiver's blockchain address 210, digital signatures, a computer operation ID, a transaction amount associated with the operation, a timestamp, status (e.g., confirmed) of the operation, the identity of the block that includes the operation, etc. For example, operation information 142 may include records of transactions, including a transaction value, that utilized blockchain address 210 and are validated by the blockchain system 140. In various embodiments, gatherer engine 240 accesses records on the blockchain of blockchain system 140 that describe prior computer operations performed by program code 144 with respect to blockchain address 210. For example, a user may have previously be incentivized via a reward to perform a computer operation that satisfied the data inputs of program code 144.

Gatherer engine 240, in various embodiments, collects history information 234 and operation information 142 and provides the information to a prediction engine to generate a prediction. By collecting information from two sources, prediction system 130 may generate an improved prediction since it can leverage (via operation information 142) operations that are recorded on a blockchain while also leveraging (via history information 234) operations that are performed off the blockchain. In some embodiments, gatherer engine 240 may collect information from a single source prior to providing the information to a prediction engine. The prediction engine is discussed in greater detail with respect to FIG. 3.

Turning now to FIG. 2B, a block diagram of an example of prediction system 130 gathering data using gatherer engine 240 based on a cookie 250 is shown. In the illustrated embodiment, prediction system 130 includes database 220 and gatherer engine 240. As further depicted, database 220 includes user information 230 that describes blockchain information 232 and history information 234. In some embodiments, prediction system 130 is implemented differently than shown. For example, prediction system 130 and gatherer engine 240 may be implemented separately.

As a user interacts with one or more websites via a web browser, the web browser may store one or more cookies 250 on user device 110. Cookie 250, in various embodiments, is data that is created by a web server while a user is browsing a website. Cookie 250 may include identification information (e.g., login credentials), browsing behavior (e.g., websites visited), website settings (e.g., theme settings), etc. For example, cookie 250 may store login credentials associated with a particular web service system 120, such as a user ID and password. User ID 252, in various embodiments, is a unique identifier associated with the user of user device 110. User ID 252 may correspond to an identifier that is generated by prediction system 130 and linked to a user account at prediction system 130. Accordingly, user ID 252 may be used to access records pertaining to the user of user device 110 that are stored at database 220. In various embodiments, web service system 120 extracts identification information, such as user ID 252, from one or more cookies 250 to generate and send prediction request 215.

In the illustrated embodiment, prediction request 215 is received by gatherer engine 240. In response to receiving prediction request 215, gatherer engine 240 may extract identification information from prediction request 215, such as user ID 252, in order to identify and collect blockchain information 232 and history information 234 stored in database 220. Blockchain information 232, in various embodiments, includes information associated with the user with respect to blockchain system 140. Blockchain information 232 may include the user's blockchain address 210, transaction history using that blockchain address 210, current balance, etc. Accordingly, gatherer engine 240 may use user ID 252 to identify a blockchain address 210 stored in database 220 associated with the user of user device 110. As previously described with respect to FIG. 2A, gatherer engine 240 may use that blockchain address 210 to obtain operation information 142. After obtaining history information 234 and/or operation information 142, gatherer engine 240 provides the collected information to a prediction engine in order to generate a prediction.

Turning now to FIG. 3, a block diagram of an example of prediction engine 310 generating a prediction 320 is shown. In the illustrated embodiment, prediction system 130 includes database 220, gatherer engine 240, and a prediction engine 310. As further depicted, database 220 includes user information 230 that comprises blockchain information 232 and history information 234. As further shown, prediction engine 310 includes a machine learning (ML) model 312 and prediction criteria 314. In some embodiments, prediction system 130 is implemented differently than shown. For example, prediction engine 310 may not utilize ML model 312 to produce prediction 320.

Prediction engine 310, in various embodiments, is software executable to generate prediction 320 that indicates a likelihood as to whether a user of user device 110 will perform a set of operations with respect to web service system 120. For example, prediction engine 310 may generate a prediction as to whether a user will create a user account associated with web service system 120. Prediction engine 310 receives operation information 142 and history information 234 from gatherer engine 240 (as shown) and may process information 142 and 234 using a ML model 312.

ML model 312, in various embodiments, is a probabilistic model (e.g., a logistic regression model) that calculates a score (e.g., probability) which indicates whether a user will perform a set of computer operations based on features from operation information 142 and/or history information 234. Using supervised machine learning techniques, prediction engine 310 may train ML model 312 based on a set of features extracted from an existing data set with labels. For example, ML model 312 may process a set of features (e.g., features relating to a user's browsing behavior, purchasing behavior, demographic, search queries, etc.) extracted from a training set of information 142 and 234 to generate prediction 320. Prediction 320 may be represented as a numerical score and a higher score may be indicative of a higher probability that the user will perform the computer operation.

After calculating a score, prediction engine 310 may implement a loss function, such as cross-entropy loss, to calculate a loss value that represents the error between the predicted score and a desired/true score. For example, ML model 312 may calculate a score that indicates that a particular user will not create an account on a website, and this score may be compared to the true score that indicates that the user did create an account. Based on this loss value, prediction engine 310 may adjust a set of parameters (e.g., weights and/or bias) used by ML model 132 to minimize the loss value. This training process can be repeated until the loss value satisfies a predefined threshold. Using the parameters learned during the training process, ML model 312 may further generate one or more predictions 320 based on operation information 142 and/or history information 234.

In various embodiments, prediction engine 310 generates prediction 320 based on prediction criteria 314. Prediction criteria 314 may include various criteria relating to a user's browsing behavior, purchasing behavior (e.g., cost of item), demographic information (e.g., age), search queries (e.g., keywords), seasonal trends (e.g., time of year), etc. based on the data included in operation information 142 and history information 234. For example, prediction engine 310 may determine that a user has performed a particular computer operation (e.g., sign up) on five or more web service systems 120. As a result, prediction engine 310 may calculate a score for prediction 320 indicating that the user will likely perform the computer operation on a new web service system 120.

Purchasing behavior may include types of products purchased by the user, transaction amounts, purchase frequency, repeat purchases, responses to discounts or promotions, etc. For example, prediction engine 310 may determine that a user purchased two or more products at a specific price range, and thus prediction engine 310 may determine that the user is likely to perform a similar transaction. As another example, prediction engine 310 may determine that a price for a particular product is higher than the prices of products that a user has historically purchased. As a result, prediction engine 310 may calculate a score indicating that the user will not conduct the transaction for the particular product. Prediction criteria 314 may specify other resource cost criteria that assess the time involved in performing a certain computer operation, the amount of computer resources involved that computer operation, etc. As such, prediction 320 may be generated based on the resource cost for a user to perform a particular computer operation with web service system 120.

Browsing behavior may include time spent on one or more websites, types of pages visited, search queries, clicking patterns, return visits, etc. As an example, if a user interacts mainly with the same web service system 120, then prediction engine 310 may calculate, for another web service system 120, a score for prediction 320 indicating that the user is not likely to interact with this other web service system 120. That is, prediction 320 may be generated based on a number of web service systems 120 for which a user has previously performed a certain computer operation. After generating prediction 320, prediction system 130 may then provide prediction 320 to web service system 120.

In various embodiments, prediction engine 310 evaluates records on the blockchain of blockchain system 140 that describe previous computer operations performed by program code 144 with respect to blockchain address 210. For example, prediction engine 310 may determine that the user was previously incentivized to perform a computer operation based on a particular reward value. Prediction engine 310 may include that information with prediction 320 such that web service system 120 may determine the reward based on those records in lieu of the prediction score.

Turning now to FIG. 4, a block diagram of an example of a deployment and invocation of program code 144 is shown. In the illustrated embodiment, there are web service systems 120 and 120B, prediction system 130, and blockchain system 140. As shown, prediction system 130 includes database 220 and a deployment engine 460. Also as shown, blockchain system 140 includes nodes 430A-D that store a copy of a blockchain 450 that comprises blocks 440A and 440B with program code 144A and 144B. In some embodiments, the deployment and invocation of program code 144 is implemented differently than shown. For example, web service system 120A and/or 120B may deploy program code 144A and/or 144B on blockchain 450 instead of prediction system 130.

In the illustrated embodiment, blockchain system 140 comprises distributed nodes 430A-D. A node 430, in various embodiments, is a computing device that stores a copy of blockchain 450 and ensures that transactions posted to a block 440 of blockchain 450 are valid. A node 430 may add more blocks 440 to blockchain 450 as a part of processing transactions, including a transaction to store program code 144 on blockchain 450 based on a deployment request 410 from deployment engine 460.

Deployment engine 460, in various embodiments, is software executable to broadcast a deployment request 410 to blockchain system 140. A deployment request 410, in various embodiments, is a request to execute a deployment transaction that deploys program code 144 to a block 440 of blockchain 450. A deployment request 410 may include a data payload that comprises program code 144 from database 220, including parameters required for executing functions/methods of program code 144. In response to receiving a deployment request 410 from deployment engine 460, the receiving node(s) 430 include the program code 144 in a block 440 that they attempt to add to blockchain 450. In response to successfully adding the block 440, receiving nodes 430 broadcast, to the remaining nodes 430, the inclusion of the block 440 on the blockchain 450. The remaining nodes 430 validate the inclusion of the block 440 and include the block 440 on their respective copy of blockchain 450. In response to including program code 144 in a block 440 of blockchain 450, a unique address is generated and assigned to program code 144 In various cases, the address assigned to particular program code 144 is specified in a deployment request 410 used to deploy it.

As shown, deployment engine 460 issues deployment requests 410 to deploy program code 144A and 144B onto blockchain 450. Program code 144A may be deployed on behalf of web service system 120A and designed to perform a set of computer operations in response to a user interacting with web service system 120A to perform another set of computer operations. Similarly, program code 144B may be deployed on behalf of web service system 120B and designed to perform a set of computer operations in response to a user interacting with web service system 120B to perform another set of computer operations. The operations performed by program code 144A may be the same or different than the operations performed by program code 144B. In some embodiments, program code 144A and 144B perform different operations and are invokable by both web service systems 120A and 120B-that is, program code 144A and 114B may not be deployed on behalf of a specific web service system 120.

To facilitate the execution of program code 144, web service systems 120 broadcast invocation requests 420 to blockchain system 140. An invocation request 420, in various embodiments, is a request to execute a transaction that invokes a function/method of program code 144. An invocation request 420 may include a set of input data, such as the address of program code 144, the blockchain address 210 associated with a particular user, a blockchain address 210 associated with the relevant web service system 120, a transaction value between the user and that web service system 120, and/or a value of a reward for the user performing the computer operation. The set of input data may be determined based on prediction 320. For example, a prediction 320B may indicate a mid-range probability of a user performing a particular computer operation at web service system 120B. As a result, web service system 120B may customize the input data included in its invocation requests 420B, such as specifying a greater reward, to incentivize the user to perform the particular computer operation. But web service system 120A may determine, based on a prediction 320A, that a user is very likely to perform a particular computer operation at web service system 120A. As a result, web service system 120A may customize the input data included in its invocation requests 420A, such as specifying a low reward, as the user does not need to be incentivized to perform the particular computer operation.

In various embodiments, the reward is determined by the value of the score calculated using ML model 312 and/or prediction criteria. The value of the reward may be the inverse of the prediction score such that a higher score equates to a lower reward value and a lower score equates to a higher reward value. For example, a higher score indicates that a user is likely to perform a transaction with web service system 120 and therefore the user may not need to be incentivized via a greater reward since the user likely to perform the transaction anyways. In some embodiments, the value of the reward is determined based on the prediction score falling within a particular range of prediction scores. For example, the score may fall within a range of 0 to 0.3, and as result, web service system 120 may decide not to offer a reward as the user is not likely to perform the computer operation. Similarly, the score may fall within a range of 0.7 to 1, and thus, web service system 120 may decide not to offer a reward as the user is likely to perform the computer operation. Finally, the score may fall within a range of 0.3 to 0.7, and thus web service system 120 may decide to offer a reward.

Furthermore, scores may vary between users and thus a reward may be offered to one user but not to another user. Also, the rewards offered to users may be different—e.g., a first user may be offered cryptocurrency, a second user may be offered a discount, a third user may be offered redeemable points, and a fourth user may be offered cash. In various embodiments, the value of the reward is determined based on the value of prior rewards that have incentivized one or more users based on their respective scores. For example, a particular value for a reward may have successfully caused one or more users with a score between 0.5 and 0.6 to perform a sign-up. As a result, if web service system 120 receives another prediction score within that range, it may determine to issue the same or similar reward. In some embodiments, the reward may be different between different instances of an operation (e.g., transactions) performed by a user. As an example, a discount may be provided for a first transaction while a stablecoin is provided for a second transaction. Further, the value of the reward may vary between different instances of an operation performed by a user—e.g., the user may receive a larger discount for a first transaction than a second transaction.

As part of executing the transaction in response to receiving an invocation request 420, the receiving node(s) 430 execute the relevant program code 144 to monitor blockchain 450 for one or more records that satisfies the input data specified by that invocation request 420. For example, one or more nodes 430 may monitor blockchain 450 for a record that describes a transaction between the user and web service system 120 that includes a particular transaction value. In response to detecting a record in blockchain 450 that satisfies the input values, nodes 430 may execute one or more additional functions/methods of the relevant program code 144. For example, nodes 430 may execute a transfer function of program code 144A to transfer a reward (as specified by the received invocation request 420) to the blockchain address 210 of the user from a blockchain address 210 of web service system 120. If the user does not perform the computer operation, then the relevant program code 144 may not detect any record (as one is not created) and thus may not execute additional functions, such as the transfer function to transfer the reward to the user.

In various cases, despite being issued by web service system 120, the reward may not be bound to web service system 120 such that is usable only at web service system 120. That is, the reward may be used with other entities. For example, a user may receive a stablecoin as a reward from a first merchant and use that stablecoin to perform a transaction with a second merchant. Since the reward can be issued via blockchain technology, the reward may also not expire as long as blockchain system 140 is maintained—e.g., a user may use the stablecoin even in the event that the merchant ceases to exist. Due to this property, a user may be incentivized more by one reward (e.g., a stablecoin) than another reward (e.g., points at a merchant) and thus the reward offered to the user may be based on this paradigm.

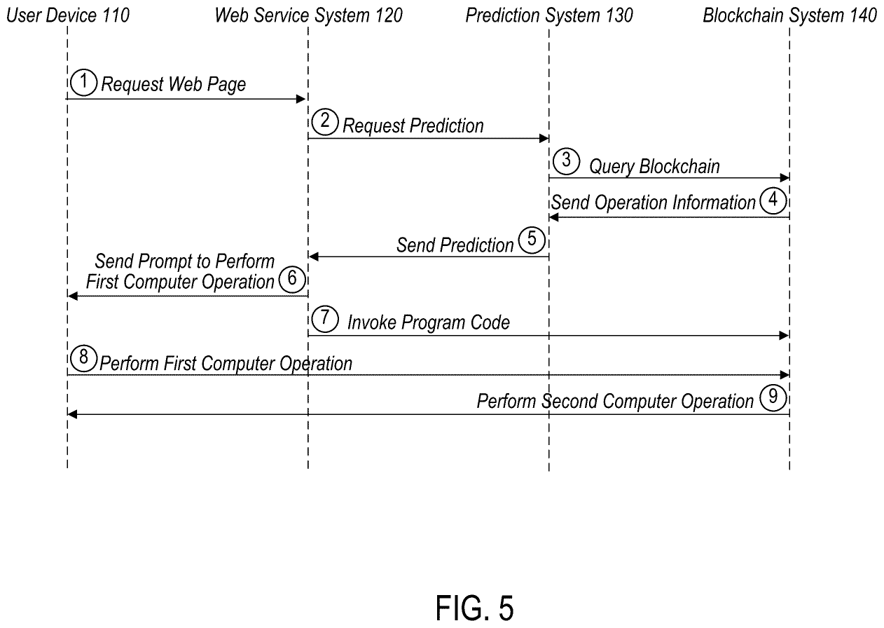

Turning now to FIG. 5, a flow diagram of an example execution flow pertaining to web service system 120 invoking program code 144 based on a prediction 320 from prediction system 130 is shown. In the illustrated embodiment, there is user device 110, web service system 120, prediction system 130, and blockchain system 140. In some embodiments, the execution flow is implemented differently than shown. For example, there may be a step in which prediction system 130 deploys program code 144 onto blockchain 450 of blockchain system 140.

In the illustrated flow diagram, web service system 120 (e.g., a merchant system) provides a reward to a user in response to the user performing an operation (e.g., a transaction to obtain a product) with web service system 120. Issuing a reward to the user may involve a smart contract on the blockchain that is capable of assessing the blockchain for an indication that the user has performed the operation (e.g., a blockchain block that includes the transaction between the user and the merchant system) and issuing the reward to the user via a transaction on the blockchain in response to determining, from that indication, that the user has performed the operation with web service system 120. Web service system 120 can provide inputs various to the smart contract to enable it to issue the reward, such as the reward's type, the reward's value, a source address (e.g., a merchant's blockchain address), a destination address (e.g., the user's blockchain address), and the operation (e.g., the value of the transaction). The reward can take the form of a stablecoin. In some embodiments, the smart contract can interact with a system, such as web service system 120, that is external to the blockchain and blockchain system 140. Thus, the smart contract may interact with another system (e.g., a banking system) to issue the reward (e.g., cash) to the user.

At step 1, web service system 120 receives network traffic from user device 110. For example, web service system 120 may receive an HTTPs (hypertext transfer protocol secure) request to access a website implemented by web service system 120. A user of user device 110 may access one or more webpages of the website that pertain to products listed by web service system 120. At step 2, in response to receiving the network traffic or in response to an action performed by the user (e.g., selecting a product), web service system 120 sends a prediction request 215 to prediction system 130. That prediction request 215 may include a blockchain address 210 associated with the user of user device 110. At step 3, prediction system 130 then queries blockchain 450 in blockchain system 140 to locate operation information 142 that is associated with the obtained blockchain address 210. For example, prediction system 130 may identify one or more records that describe transactions performed by the user that involve the user's blockchain address 210.

At step 4, prediction system 130 receives operation information 142 from blockchain system 140. Prediction system 130 may thereafter generate prediction 320 based on operation information 142. For example, prediction system 130 may determine that the user is likely to become a long-term customer of web service system 120 and thus generate prediction 320 accordingly. At step 5, prediction system 130 provides the generated prediction 320 to web service system 120. At step 6, based on the received prediction 320, web service system 120 may determine to send a prompt to user device 110 in order to incentivize the user to perform a particular computer operation (e.g., conduct a transaction to obtain a product). The prompt may include one or more discount codes, special offers, abandoned cart reminders, feedback requests, newsletter sign-ups, etc. For example, a user may receive a notification via a web browser of user device 110 that indicates the user may receive a reward after completing a transaction with web service system 120. At step 7, web service system 120 invokes program code 144 stored on blockchain 450 of blockchain system 140. For example, web service system 120 may provide inputs (e.g., the user's blockchain address 210, the value of the transaction, the value of the reward, etc.) that cause program code 144 to issue the reward in response to detecting that the user has completed the transaction with web service system 120.

At step 8, the user has successfully performed the computer operation as predicted by prediction 320, and the computer operation is validated and written to blockchain 450 of blockchain system 140. For example, the user may have completed a transaction with web service system 120 using their blockchain address 210, and thus, the transaction is recorded on a block 440 of blockchain 450 in association with that blockchain address 210. At step 9, if the additional record satisfies the parameters specified by an invocation request 420 (e.g., the recorded value of the transaction matches or is greater than the transaction value provided by web service system 120 to program code 144 at step 7), then program code 144 executes the specified function. to perform a second computer operation with respect to the user of user device 110. For example, program code 144 may execute a function to initiate a transaction on blockchain 450 that transfers a rewarded amount of a stablecoin from a blockchain address 210 associated with web service system 120 to the user's blockchain address 210.

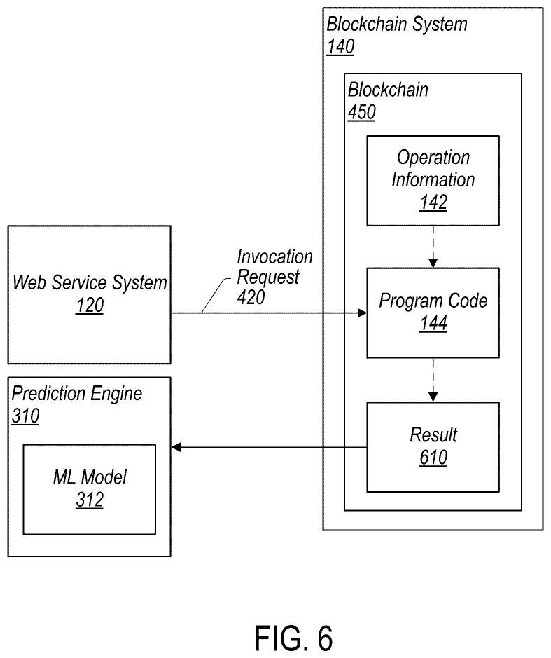

Turning now to FIG. 6, a block diagram of an example of prediction engine 310 updating ML model 312 based on a result 610 is shown. In the illustrated embodiment, the update process includes web service system 120, blockchain system 140, and prediction engine 310. As further depicted, blockchain system 140 includes blockchain 450 with operation information 142, program code 144, and result 610. As further depicted prediction engine 310 includes ML model 312. In some embodiments, the update process is implemented differently than shown. For example, program code 144 may execute a function to send result 610 directly to prediction engine 310.

Prediction engine 310, in various embodiments, updates a set of parameters (e.g., weights and/or bias) used by ML model 312 based on result 610. Result 610, in various embodiments, is a record on blockchain 450 that describes an outcome associated with the execution of program code 144. Prediction engine 310, in various embodiments, converts result 610 into a score that indicates whether the user has successfully performed the operation as specified by invocation request 420. For example, result 610 may be represented as a value of “1” which indicates that the operation has been performed by the user. Prediction engine 310 may use a loss function, such as cross-entropy loss, to calculate a loss value that represents the error between the predicted score (e.g., corresponding to prediction 320) and the score that represents result 610. For example, ML model 312 may have initially calculated a score that incorrectly indicated that the user will not perform a transaction with web service system 120. Based on this loss value, prediction engine 310 adjusts the set of parameters used by ML model 132 to minimize the loss value. By adjusting the set of parameters, prediction engine 310 may refine ML model 132 such that it produces improved predictions 320.

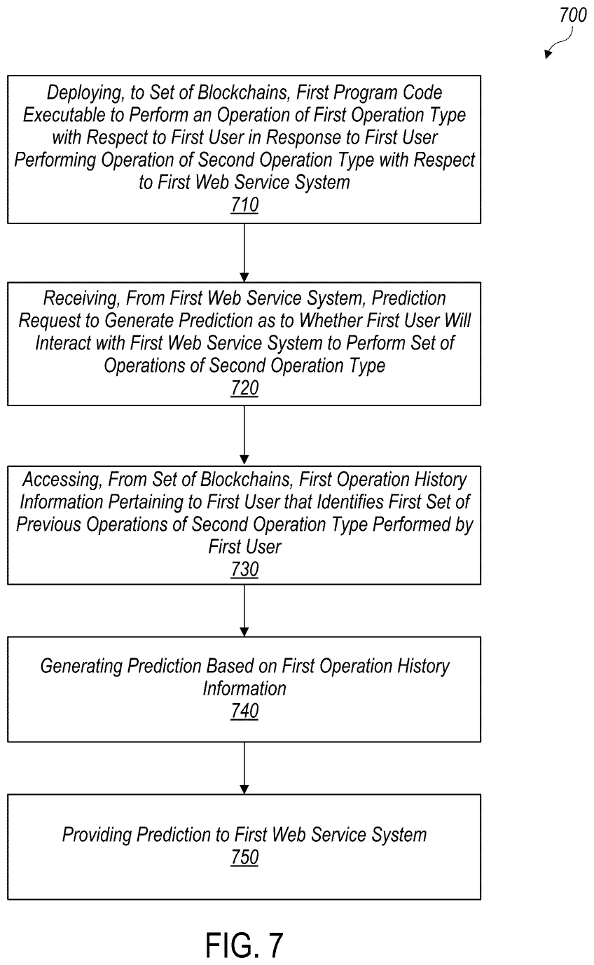

Turning now to FIG. 7, a flow diagram of a method 700 is shown. Method 700 is one embodiment of a method performed by a computer system (e.g., system 100) to generate a prediction (e.g., prediction 320) as to whether the user will interaction with the web service system (e.g., web service system 120) to perform a set of computer operations. Method 700 may be performed by executing program instructions stored on a non-transitory computer-readable medium. Method 700 may include more or less steps than shown. For example, method 700 may include a step in which the prediction system accesses operation history information (e.g., history information 234) not included on the blockchain.

Method 700 begins in step 710 with the computer system deploying first program code (e.g., program code 144), to a set of blockchains, executable to perform an operation of a first operation type with respect to a first user (e.g., user device 110) in response to the first user performing an operation of a second operation type with respect to a first web service system (e.g., web service system 120). In various embodiments, the first program code includes a set of input variables that enable the first web service system to provide, when the first program code is invoked by the first web service system, a set of inputs that affect the operation of the first operation type with respect to the first user. In various embodiments, the first program code is associated with the first web service system. The computer system may deploy, to the set of blockchains, second program code that is executable to perform an operation of the first operation type with respect to the first user in response to the first user performing an operation of the second operation type with respect to a second web service system.

In various embodiments, the first program code is executable to perform an operation of the first operation type with respect to the first user in response to the first user performing an operation of the second operation type with respect to a second web service system. In various embodiments, the first program code is executable to perform an operation of the first operation type with respect to a second user in response to the second user performing an operation of the second operation type with respect to the first web service system.

In step 720, the computer system receives, from the first web service system, a prediction request (e.g., prediction request 215) to generate a prediction (e.g., prediction 320) as to whether the first user will interact with the first web service system to perform a set of operations of the second operation type. In various embodiments, the prediction request identifies a blockchain address (e.g., blockchain address 210) associated with the first user. In step 730, the computer system accesses, from the set of blockchains, first operation history information pertaining to the first user that identifies a first set of previous operations of the second operation type performed by the first user. The first operation history (e.g., operation information 142) information may be accessed from the set of blockchains (e.g., chain 450) based on the blockchain address.

In step 740, the computer system generates the prediction based on the first operation history information. In various embodiments, the prediction is generated based on a resource cost for the first user associated with performing at least one of the set of operations of the second operation type with respect to the first web service system. In various embodiments, the prediction is generated based on a number of web service systems with respect to which the first user has performed operations of the second operation type, as indicated by the first operation history information. In various embodiments, the computer system maintains second operation history information (e.g., history information 234) stored in a database (e.g., database 220) of the prediction computer system that is distinct from the set of blockchains. The second operation history information may identify a second set of previous operations of the second operation type performed by the first user. The prediction may also be generated based on the second operation history information.

In various embodiments, the prediction is generated using a machine learning model (e.g., ML model 312) trained on previously performed operations of the second operation type. The computer system may obtain an outcome indication (e.g., result 610) that identifies whether the first user performed the operation of the second operation type with respect to the first web service system. The computer system may update the machine learning model based on the outcome indication. In step 750, the computer system provides the prediction to the first web service system.

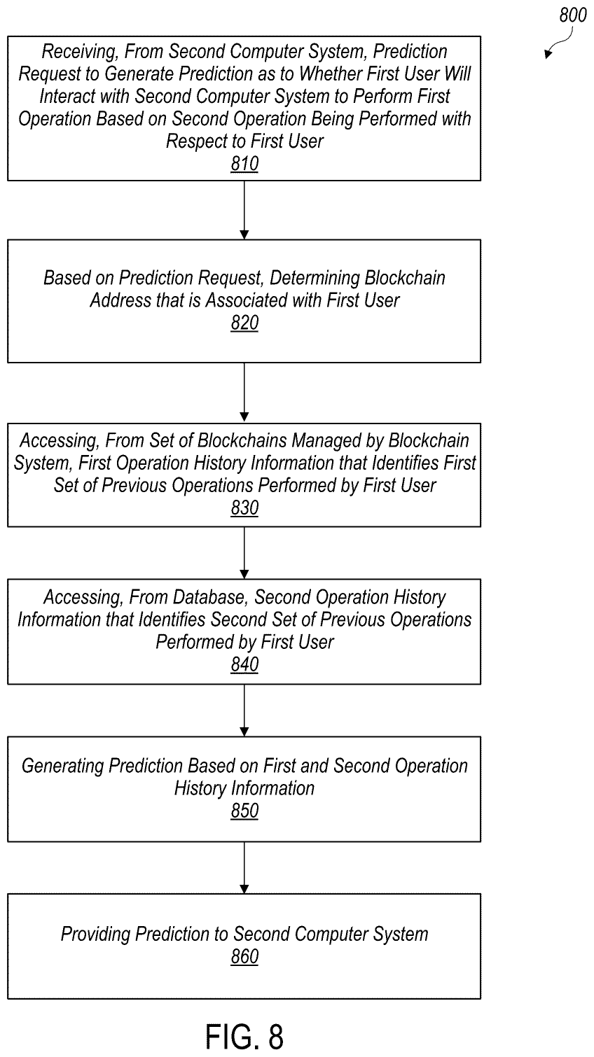

Turning now to FIG. 8, a flow diagram of a method 800 is shown. Method 800 is one embodiment of a method performed by a computer system (e.g., system 100) to generate a prediction (e.g., prediction 320) as to whether the user will interaction with a web service system (e.g., web service system 120) to perform a set of computer operations. Method 800 may be performed by executing program instructions stored on a non-transitory computer-readable medium. Method 800 may include more or less steps than shown. For example, method 800 may not include step 840 in which the prediction system accesses the second operation history information.

Method 800 begins in step 810 with the computer system receiving, from a second computer system (e.g., web service system 120), a prediction request (e.g., prediction request 215) to generate a prediction as to whether a first user (e.g., a user of user device 110) will interact with the second computer system to perform a first operation based on a second operation being performed with respect to the first user.

In step 820, based on the prediction request, the computer system determines a blockchain address (e.g., blockchain address 210) that is associated with the first user. In various embodiments, the prediction request includes a cookie (e.g., cookie 250) issued to a user device of the first user by the computer system. Based on the cookie, the computer system may access, from blockchain address information stored in a database (e.g., database 220), the blockchain address from a plurality of blockchain addresses associated with a plurality of users of the computer system.

In step 830, the computer system accesses, from a set of blockchains managed by a blockchain system (e.g., blockchain system 140), first operation history information (e.g., operation information 142) that identifies a first set of previous operations performed by the first user. The first operation history information may be accessed based on the blockchain address. In step 840, the computer system accesses, from a database managed by the computer system, second operation history information (e.g., history information 234) that identifies a second set of previous operations performed by the first user. In step 850, the computer system generates the prediction (e.g., prediction 320) based on the first and second operation history information. In step 860, the computer system provides the prediction to the second computer system.

In various embodiments, the computer system sends, to the blockchain system, a request to store program code (e.g., program code 144) executable to perform the second operation with respect to the first user in response to the first user performing the first operation with respect to the second computer system. In various embodiments, the program code includes a set of input variables that enable the second computer system to provide, when the program code is invoked by the second computer system, a set of inputs that affect the second operation with respect to the first user. In various embodiments, the program code is executable to perform a third operation with respect to a second user in response to the second user performing a fourth operation with respect to the second computer system.

### Exemplary Computer System

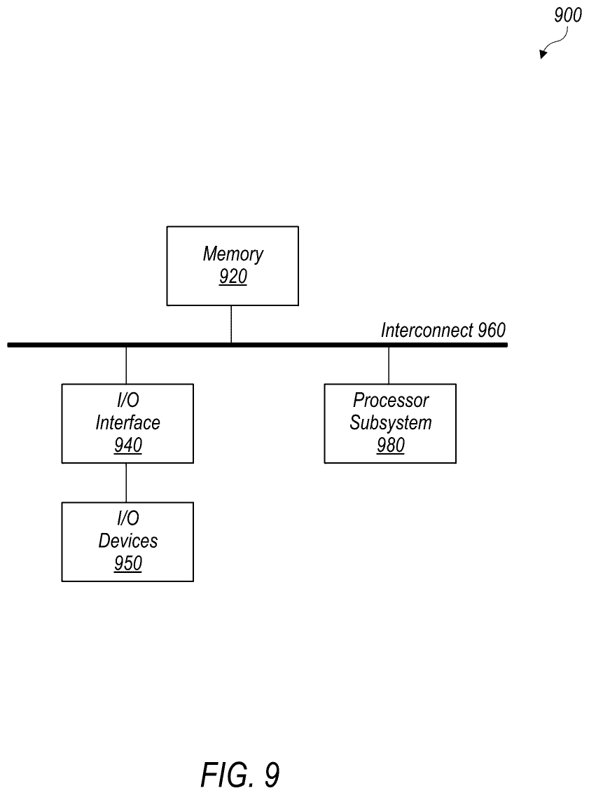

Turning now to FIG. 9, a block diagram of an exemplary computer system 900, which may implement system 100, user device 110, web service system 120, prediction system 130, and/or blockchain system 140, is shown. Computer system 900 includes a processor subsystem 980 that is coupled to a system memory 920 and I/O interfaces(s) 940 via an interconnect 960 (e.g., a system bus). I/O interface(s) 940 is coupled to one or more I/O devices 950. Although a single computer system 900 is shown in FIG. 9 for convenience, system 900 may also be implemented as two or more computer systems operating together.

Processor subsystem 980 may include one or more processors or processing units. In various embodiments of computer system 900, multiple instances of processor subsystem 980 may be coupled to interconnect 960. In various embodiments, processor subsystem 980 (or each processor unit within 980) may contain a cache or other form of on-board memory.

System memory 920 is usable store program instructions executable by processor subsystem 980 to cause system 900 perform various operations described herein. System memory 920 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 900 is not limited to primary storage such as memory 920. Rather, computer system 900 may also include other forms of storage such as cache memory in processor subsystem 980 and secondary storage on I/O Devices 950 (e.g., a hard drive, storage array, etc.). In some embodiments, these other forms of storage may also store program instructions executable by processor subsystem 980. In some embodiments, program instructions that when executed implement database 220, gatherer engine 240, prediction engine 310, a node 430, and/or deployment engine 460 may be included/stored within system memory 920.

I/O interfaces 940 may be any of various types of interfaces configured to couple to and communicate with other devices, according to various embodiments. In one embodiment, I/O interface 940 is a bridge chip (e.g., Southbridge) from a front-side to one or more back-side buses. I/O interfaces 940 may be coupled to one or more I/O devices 950 via one or more corresponding buses or other interfaces. Examples of I/O devices 950 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 900 is coupled to a network via a network interface device 950 (e.g., configured to communicate over WiFi, Bluetooth, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
deploying, by a prediction computer system to a set of blockchains, first program code executable to perform an operation of a first operation type with respect to a first user in response to the first user performing an operation of a second operation type with respect to a first web service system;
receiving, by the prediction computer system from the first web service system, a prediction request to generate a prediction as to whether the first user will interact with the first web service system to perform a set of operations of the second operation type;
accessing, by the prediction computer system from the set of blockchains, first operation history information pertaining to the first user that identifies a first set of previous operations of the second operation type performed by the first user;
generating, by the prediction computer system, the prediction based on the first operation history information; and
providing, by the prediction computer system, the prediction to the first web service system.

2. The method of claim 1, wherein the prediction is generated based on a resource cost for the first user associated with performing at least one of the set of operations of the second operation type with respect to the first web service system.

3. The method of claim 1, wherein the prediction is generated based on a number of web service systems with respect to which the first user has performed operations of the second operation type, as indicated by the first operation history information.

4. The method of claim 1, wherein the method further comprises:
maintaining, by the prediction computer system, second operation history information stored in a database of the prediction computer system that is distinct from the set of blockchains, wherein the second operation history information identifies a second set of previous operations of the second operation type performed by the first user, and wherein the prediction is generated based on the second operation history information.

5. The method of claim 1, wherein the first program code includes a set of input variables that enable the first web service system to provide, when the first program code is invoked by the first web service system, a set of inputs that affect the operation of the first operation type with respect to the first user.

6. The method of claim 1, wherein the first program code is associated with the first web service system, and wherein the method further comprises:
deploying, by the prediction computer system to the set of blockchains, second program code executable to perform an operation of the first operation type with respect to the first user in response to the first user performing an operation of the second operation type with respect to a second web service system.

7. The method of claim 1, wherein the first program code is executable to perform an operation of the first operation type with respect to the first user in response to the first user performing an operation of the second operation type with respect to a second web service system.

8. The method of claim 1, wherein the first program code is executable to perform an operation of the first operation type with respect to a second user in response to the second user performing an operation of the second operation type with respect to the first web service system.

9. The method of claim 1, wherein the prediction request identifies a blockchain address associated with the first user, and wherein the first operation history information is accessed from the set of blockchains based on the blockchain address.

10. The method of claim 1, wherein the prediction is generated using a machine learning model trained on previously performed operations of the second operation type, and wherein the method further comprises:
obtaining, by the prediction computer system, an outcome indication that identifies whether the first user performed the operation of the second operation type with respect to the first web service system; and
updating, by the prediction computer system, the machine learning model based on the outcome indication.

11. A non-transitory computer-readable medium having program instructions stored thereon that are executable to cause a first computer system to perform operations comprising:
deploying, to a set of blockchains managed by a blockchain system, first program code executable to perform an operation of a first operation type with respect to a first user in response to the first user performing an operation of a second operation type with respect to a first web service system;
receiving, from the first web service system, a prediction request to generate a prediction as to whether the first user will interact with the first web service system to perform a set of operations of the second operation type;
accessing, from the set of blockchains using a blockchain address associated with the first user, operation history information pertaining to the first user that identifies a set of previous operations of the second operation type performed by the first user;
generating the prediction based on the operation history information; and
providing the prediction to the first web service system.

12. The non-transitory computer-readable medium of claim 11, wherein the generating includes:
determining, based on the operation history information, whether the first user has performed operations of the second operation type with multiple web service systems within a particular period of time, wherein the prediction is generated based on the determining.

13. The non-transitory computer-readable medium of claim 11, wherein the operations further comprise:
deploying, to the set of blockchains, second program code executable to perform an operation of the first operation type with respect to a second user in response to the second user performing an operation of the second operation type with respect to a third computer system.

14. The non-transitory computer-readable medium of claim 11, wherein the prediction request includes identity information pertaining to the first user that is included in a cookie issued to a user device of the first user, and wherein the operations further comprise:
maintaining user information that maps a plurality of users of the first computer system to a plurality of blockchain addresses; and
obtaining, from the user information based on the identity information, the blockchain address from the plurality of blockchain addresses.

15. The non-transitory computer-readable medium of claim 11, wherein the operations further comprise:
obtaining an outcome indication that identifies whether the first user performed the operation of the second operation type with respect to the first web service system; and
generating, for the first web service system, another prediction that is based on the outcome indication.

16. A method, comprising:
receiving, by a first computer system from a second computer system, a prediction request to generate a prediction as to whether a first user will interact with the second computer system to perform a first operation based on a second operation being performed with respect to the first user;
based on the prediction request, the first computer system determining a blockchain address that is associated with the first user;
accessing, by the first computer system from a set of blocks managed by a blockchain system, first operation history information that identifies a first set of previous operations performed by the first user, wherein the first operation history information is accessed based on the blockchain address;
accessing, by the first computer system from a database managed by the first computer system, second operation history information that identifies a second set of previous operations performed by the first user;
generating, by the first computer system, the prediction based on the first and second operation history information; and
providing, by the first computer system, the prediction to the second computer system.

17. The method of claim 16, further comprising:
sending, by the first computer system to the blockchain system, a request to store program code executable to perform the second operation with respect to the first user in response to the first user performing the first operation with respect to the second computer system.

18. The method of claim 17, wherein the program code includes a set of input variables that enable the second computer system to provide, when the program code is invoked by the second computer system, a set of inputs that affect the second operation with respect to the first user.

19. The method of claim 17, wherein the program code is executable to perform a third operation with respect to a second user in response to the second user performing a fourth operation with respect to the second computer system.

20. The method of claim 16, wherein the prediction request includes a cookie issued to a user device of the first user by the first computer system, and wherein the determining includes:
based on the cookie, the first computer system accessing, from blockchain address information stored in the database, the blockchain address from a plurality of blockchain addresses associated with a plurality of users of the first computer system.
